(19) United States
(12) Patent Application Publication
(10) Pub. No.: US 2026/0016841 A1
(43) Pub. Date: Jan. 15, 2026

(54) METHOD FOR ADJUSTING A PIEZOELECTRIC ACTUATOR

(71) Applicant: CYTENA GMBH, Freiburg (DE)

(72) Inventors: Lena LAUTSCHAM, Freiburg (DE); Marlene FIEDLER, Freiburg (DE)

(21) Appl. No.: 18/993,846

(22) PCT Filed: Jul. 9, 2023
(86) PCT No.: PCT/EP2023/068954

§ 371 Date: Jan. 13, 2025

(30) Foreign Application Priority Data
Jul. 14, 2022 (LU) LU502506

(51) Int. Cl. G05D 7/06

(52) U.S. Cl. CPC G05D 7/0623; G05D 7/0676

(57) ABSTRACT

The invention relates to a method for adjusting a piezoelectric actuator (5) of a dispensing device (1), the method having the following steps:
transmitting at least one excitation signal to the actuator (5) and
determining at least one impedance value of the excited actuator (5), wherein
the piezoelectric actuator (5) is adjusted according to the determined at least one impedance value.

The invention relates to a method for adjusting a piezoelectric actuator, a dispensing device, a data processing unit for carrying out the method, a computer program, a computer-readable data carrier and a data carrier signal.

Isolated cells are becoming an increasingly important material. Active substances such as monoclonal antibodies and other proteins are produced using so-called monoclonal cell lines. These are populations of cells all descended from a single parent cell. The production of monoclonal cell lines is necessary because this is the only way to ensure that all cells in the population have an approximately same genome in order to produce active ingredients with a consistent and reproducible quality.

To generate a monoclonal cell line, cells are individually transferred to receptacles of a microtiter plate. The cells to be transferred are produced by genetically modifying a host cell line and individualizing these modified cells. Individual cells are deposited in the microtiter plates using devices that are also referred to as dispensing devices.

Dispensing devices are known which have a dispenser containing a liquid sample. The dispenser is designed in such a way that a liquid sample, e.g., in the form of a droplet, is only dispensed after a dispenser section has been activated. The dispenser section is actuated by a piston of the dispensing device, which is actuated by a piezoelectric actuator of the dispensing device. Thus, the piston presses against the dispenser section when the piston is actuated by the piezoelectric element. The droplet speed, the droplet volume and the droplet shape depend on the piston speed and the penetration depth of the piston into the dispenser section. The penetration depth of the piston into the dispenser region can be between 5 and 10 μm (micrometers).

There is a need on the part of the users of the dispensing device for the liquid samples ejected during the dispensing processes to be comparable and/or stable, in particular with regard to their speed and/or shape and/or volume. In other words, it is desired that liquid samples with the same physical properties can be repeatedly dispensed. There is a need for the ejected liquid samples to have substantially the same speed and/or the same shape and/or the same volume.

However, this requirement cannot be easily met. Tolerances in the manufacture of the above-mentioned components are usually above 5 to 10 μm for the penetration depth. In addition, tolerances may change during operation of the dispensing device. This happens, for example, when the dispenser is replaced by another dispenser. A dispenser exchange may be necessary if a different liquid sample is to be dispensed after a dispensing process in order to avoid contamination of the liquid samples. In addition, it is possible for the piston and/or the piezoelectric actuator to have to be exchanged during maintenance and/or repair of the dispensing device.

The above-mentioned tolerances make it difficult to install the piezoelectric actuator with such precision that the piezoelectric actuator is biased with a predetermined load. The bias of the piezoelectric actuator is necessary to avoid damage to the actuator and to dispense the liquid sample with the predetermined physical properties. As a result, with the known dispensing devices it is not known with what load the piezoelectric actuator is biased. Since the penetration depth and/or piston speed depend on the bias of the actuator, liquid samples often cannot be repeatedly ejected with the same physical properties, so the ejected liquid samples are not comparable and/or stable. In particular, the ejected liquid samples often have different speeds and/or different shapes and/or different volumes.

To avoid these disadvantages, the actuator in known dispensing devices is adjusted manually. In particular, attempts are made to find an adjustment of the piezoelectric actuator that avoids the disadvantages mentioned above. However, manual adjustment is inaccurate and time-consuming.

The object of the invention is to provide a method by means of which the piezoelectric actuator can be adjusted precisely and quickly.

The object is achieved by a method for adjusting a piezoelectric actuator of a dispensing device in which the method has the following steps:
transmitting at least one excitation signal to the actuator and
determining at least one impedance value of the excited actuator, wherein
the piezoelectric actuator is adjusted according to the determined at least one impedance value.

Another object of the invention is to provide a dispensing device in which the actuator can be adjusted precisely and quickly.

This object is achieved by a dispensing device having
a dispenser for dispensing a liquid sample,
a piezoelectric actuator, and
a data processing apparatus configured to output at least one excitation signal to the actuator and to determine at least one impedance value of the excited actuator, wherein the data processing apparatus is configured to adjust the actuator according to the determined at least one impedance value.

According to the invention, it has been found that by taking the impedance into account when adjusting the actuator, repeatable and/or stable and/or comparable ejected liquid samples can be realized. In particular, the dispensed liquid samples may have substantially the same speed and/or the same shape and/or the same volume. Focusing on the impedance is advantageous because the tolerances of the components of the dispensing devices influence the impedance. Thus, adjusting the piezoelectric actuator, in particular on the basis of the determined impedance of the actuator, provides the advantage that the tolerances are taken into account when adjusting the piezoelectric actuator. In this respect, a dispenser exchange has no influence on the repeatability and/or comparability of the dispensed liquid samples. In the embodiment according to the invention, it is also no longer necessary for the piezoelectric actuator to be mechanically biased to a precise load. As explained in detail below, within the scope of the method according to the invention, a load can be ascertained by means of which the piezoelectric actuator is to be biased. In the method according to the invention there is therefore no longer any need to find an optimal bias through manual experimentation. Therefore, the piezoelectric actuator can be adjusted quickly and precisely using this method.

For the purposes of the invention, a dispensing device is understood to be an apparatus by means of which one or more liquid samples are dispensed only after the dispenser has been actuated. The dispenser can be actuated directly or indirectly by the actuator. The dispensing device may have a piston which is actuated by the actuator when the actuator receives an excitation signal. The dispenser is configured in such a way that the liquid sample in the dispenser cannot be dispensed without actuation by the piston or actuator. By means of the dispensing device, in particular by actuating the piston accordingly, a predetermined volume can be dispensed, which can contain a predetermined number of particles. The above features distinguish a dispensing device from a flow cytometer, which does not allow a predetermined dispensing of liquid samples by actuating a piston or actuator.

The liquid sample dispensed by means of the dispensing device, in particular by the dispenser, can be a droplet, in particular a free-flying droplet. The liquid droplet may have a volume in a range between 1 fL (femtoliter) and 1 μL (microliter), in particular between 1 pL (picoliter) and 1 μL (microliter). The sample can be dispensed according to a drop-on-demand mode of operation. In this case, the device dispenses samples discretely and not continuously. Alternatively, the liquid sample that is dispensed can be a jet which, after being dispensed from the dispenser, may break up into individual liquid droplets.

The liquid sample dispensed from the dispensing device may contain liquid and no particles in dispensing mode, i.e., during a mode in which the piezoelectric actuator is already adjusted. Alternatively, the dispensed liquid sample may have liquid and a single particle. In addition, the dispensed liquid sample may have liquid and more than a single particle.

The particles can be biological particles, and the biological particles can be microorganisms such as bacteria, archaea, yeast, fungi, and viruses, or cells, DNA, RNA, or proteins. The liquid sample may contain one or more of the aforementioned biological particles. The liquid can be a suspension that can promote a growth of the biological particles disposed in the liquid. Alternatively, the particle may be a glass or polymer bead, particularly having the same or substantially the same volume as a cell.

The piezoelectric actuator can be designed in stack form. In this case, the piezoelectric actuator has multiple, in particular piezoceramic, elements. The individual elements are connected to each other. In an alternative embodiment, the piezoelectric actuator can also have only a single, in particular piezoceramic, element. Regardless of the design of the actuator, the element can have any shape. The element can be polygonal, disk-like or tubular. The piezoelectric actuator also has electrodes for applying an electric field to the element or elements. The actuator and thus the elements can be mechanically biased by a biasing apparatus. Preloading is understood to mean a compressive force which is exerted on the elements by the biasing apparatus and by means of which the elements are pressed together.

The excitation signal is a signal that is applied to the piezoelectric actuator to deflect the actuator. In a dispensing device that also has the piston, a deflection of the actuator also causes a deflection of the piston. After being actuated by the actuator, the piston can move linearly, in particular only linearly. As described in more detail below, the excitation signal applied to the actuator in an adjustment mode for adjusting the piezoelectric actuator differs from an excitation signal applied to the actuator in a dispensing mode for dispensing a liquid sample.

The determined impedance value is an impedance value of the piezoelectric actuator. It has been found that the impedance value depends on the bias applied to the actuator. In the present case, therefore, the dispenser and the biasing apparatus influence the impedance value because the bias is adjusted via the biasing apparatus and the dispenser as a counter-load element. If the dispensing device has a piston, the piston also influences the impedance value. It is clear that the method can be used to determine several impedance values that depend on the frequency of the excitation signal.

In a special embodiment, the excitation signal can be a voltage signal, in particular a sinusoidal one. The excitation signal can be within a frequency range. The frequency range can be selected such that it comprises the resonance frequency of the actuator. In addition, the excitation signal can be varied over time. In particular, the excitation signal can be a sweep signal. Thus, several impedance values can be obtained with one excitation signal.

Alternatively or additionally, several excitation signals can be sent to the actuator. The individual excitation signals can each have a sinusoidal curve. In addition, the excitation signals can differ from each other in frequency. The excitation signals can be within the previously mentioned predetermined frequency range. The excitation signals can each be a voltage signal. Thus, different excitation signals can be supplied to the actuator which differ from each other in terms of their frequency. In particular, voltages that differ in terms of frequency from one another can be applied to the actuator.

The excitation signal applied to the actuator in an adjustment mode of the actuator may differ from an excitation signal applied to the actuator in a dispensing mode. For example, the amplitude of the excitation signal applied in adjustment mode can be smaller than the amplitude of the excitation signal applied in dispensing mode. The amplitude of the excitation signal can be so small that the deflection of the actuator is not sufficient to eject a liquid sample from the dispenser. The selection of such an excitation signal in adjustment mode provides the advantage that a measuring device for measuring impedance and/or the data processing apparatus is/are not damaged.

The at least one impedance value resulting during the transmission of the excitation signal which has a frequency within the frequency range can be associated with a mechanical bias. When several excitation signals are transmitted, the resulting impedance values can each be associated with a mechanical bias. This is possible because the mechanical bias of the actuator was not changed during the impedance determination. As a result, one or more impedance values can be associated with a mechanical bias setting. Advantage is taken of this, as described in more detail below, in dispensing mode to produce comparable dispensed liquid samples.

The data received by the data processing apparatus may already contain information about the impedance. In particular, the data may represent at least one impedance value. In this case, the impedance is determined outside the data processing apparatus. Alternatively or additionally, the at least one impedance value can be determined by the data processing apparatus on the basis of the received data.

The impedance value can be determined based on the voltage across the actuator and a resistor connected through the actuator or in series with the actuator. The two values are determined by stimulating the actuator with an AC voltage with a certain frequency. In order to obtain the entire impedance spectrum, i.e., several impedance values, several impedance measurements must be carried out at different excitation frequencies.

The actuator can be biased during a determination process of the at least one impedance value. In particular, the at least one impedance value can be determined when the actuator is biased. For this purpose, the dispensing apparatus has a biasing apparatus that exerts a mechanical bias on the actuator. The actuator can be loaded against the dispenser. The dispensing device can have the piston. The piston can be arranged in the flow of force between the actuator and the dispenser. In the biased state, the actuator is in direct contact with the dispenser or with the piston. The piston is in contact with the dispenser. In an embodiment of the dispensing device without a piston, the actuator is in contact with the dispenser in the biased state. The determination process includes transmitting the at least one excitation signal and determining the at least one impedance value.

Such a structure makes it possible that, when determining the at least one impedance value, all tolerances of the above-mentioned components are taken into account and are visible in the impedance values. This allows the tolerances to be taken into account when adjusting the piezoelectric actuator. For the sake of completeness, it should be noted that tolerances of components of the dispensing device other than those mentioned above can also be taken into account when adjusting the actuator if they have an influence on the mechanical bias and thus on the impedance of the actuator.

The at least one impedance value can be determined in the adjustment mode of the dispensing device. In adjustment mode, the actuator is adjusted and/or the values required for adjusting the actuator are determined. As already described above, in adjustment mode the amplitude of the excitation signal can be smaller than the amplitude of the excitation signal in the dispensing mode of the dispensing device. The “adjustment mode” of an actuator is therefore understood to mean an operating state of the dispensing device in which the actuator is adjusted in such a way that repeatable and/or stable and/or comparable liquid samples can be dispensed in dispensing mode.

In contrast, the “dispensing mode” of the actuator is an operating state in which the actuator is operated with at least one parameter ascertained in the adjustment mode, in particular the mechanical bias and/or the excitation signal. In the dispensing mode of the dispensing device, the amplitude of the excitation signal is sufficiently high that the piston or actuator penetrates far enough into the dispenser section to dispense a liquid sample.

The adjustment mode can be carried out before the dispensing mode. This provides the advantage that the liquid samples dispensed in dispensing mode are comparable, especially with regard to, for example, shape, volume and speed. The adjustment mode can be carried out after a dispenser exchange and/or a replacement of the actuator and/or after a predetermined number of dispensing steps in each of which a liquid sample is dispensed. The adjustment mode is carried out after a predetermined number of dispensing steps in order to check whether the dispensing device is still functioning as desired.

In a particular embodiment, the data processing apparatus can determine at least one reference impedance value. In particular, several reference impedance values can be determined. To determine the at least one reference impedance value, several dispensing processes can be performed. Each of the dispensing processes may have one dispensing step or several dispensing steps, in each of which a liquid sample is dispensed. The individual dispensing processes differ in terms of the mechanical bias applied to the actuator. However, the dispensing steps within the dispensing process are carried out with the same bias.

This involves determining a physical property of the dispensing device and/or the liquid sample dispensed in a dispensing process. The data processing apparatus can check whether the physical property meets a predetermined condition. The predetermined condition is met if the physical property of a dispensed liquid sample corresponds to a predetermined physical property.

“Corresponds” also comprises the case in which the specific physical property does not exactly correspond to the predetermined physical property, but is in a predetermined tolerance range. The physical property can be determined for all liquid samples of a dispensing process. This can be repeated for every dispensing process. The physical property can be determined manually or automatically.

A physical property is considered to be any property of the dispensed liquid sample that can be measured and/or determined on the basis of measurements. The property can be an optical property of the liquid sample and/or the shape of the dispensed liquid sample. Alternatively or additionally, the property of the liquid sample may be the volume of the liquid sample and/or the speed of the liquid sample. In addition, the property can be the number of droplets dispensed after an excitation signal and/or whether each excitation signal also results in a dispensing of a liquid sample.

If a dispensing process can be ascertained in which the dispensed liquid sample or samples have a predetermined property, an impedance measurement can be carried out and at least one reference impedance value can be determined. In other words, at least one reference impedance value can be determined, and the actuator is biased during the impedance measurement with the bias applied in the dispensing process at which the physical property of the liquid sample and/or the dispensing device corresponds to the predetermined physical property.

The dispensing device may have an optical detection apparatus for optically detecting the dispensed liquid sample. The physical property of the liquid sample can be determined based on the detected liquid sample. The optical detection apparatus may have an imaging device for generating an image.

The determination of the at least one reference impedance value is carried out analogously to the at least one impedance value. This means that at least one excitation signal or several excitation signals are transmitted to the actuator, wherein the excitation signal amplitude is frequency-dependent or the excitation signals have a different frequency. The data processing apparatus determines the impedance of the excited actuator. In addition, reference is made to the above explanations. The at least one specific reference impedance value can be stored in an electrical memory of the dispensing device.

The data processing apparatus can check whether at least one adjustment condition is met. The adjustment condition may depend on the at least one reference impedance value and/or on the at least one impedance value. Alternatively or additionally, the adjustment condition may also depend on another impedance value, which is described in detail below. The data processing apparatus can adjust the actuator according to the test result.

The actuator can be adjusted by changing the mechanical bias applied to the actuator. The dispensing device may have a biasing apparatus for biasing the piezoelectric actuator. The biasing apparatus may have a motor by means of which a biasing element, such as a screw, is moved in order to change the bias applied to the actuator. Alternatively or additionally, the excitation signal sent to the data processing apparatus can be changed. In this way, the amplitude of the control signal can be changed. As a result, the actuator can be adjusted quickly and easily.

Adjusting the actuator via the mechanical bias has the advantage that the impedance value can be used as a control variable in a regulation process. In this case, several determination processes can be carried out within the adjustment mode in which at least one impedance value or several impedance values are determined. The determination processes differ from each other in terms of the mechanical bias applied to the actuator.

In contrast, the change in the control signal has no influence on the impedance, so a regulation process with impedance as a control variable in adjustment mode is not useful. However, the excitation signal, in particular the amplitude of the excitation signal, can be changed in dispensing mode according to the test result in order to adjust the actuator. For this purpose, a relationship between the excitation signal applied in a dispensing mode and the test result can be stored. It is thus known which excitation signal is to be applied to the actuator in dispensing mode if, for example, a certain impedance value differs from a reference impedance value. The relationship between the excitation signal in dispensing mode and the test result can be determined in a laboratory, in particular once.

The test result can, for example, be the deviation of the determined impedance value from the reference impedance value. Further test results that can be used to determine the excitation signal are mentioned below.

The determination of at least one reference impedance value can be part of the adjustment mode. The reference impedance values can be determined once, in particular in a laboratory, and used for all dispensing devices. Alternatively or additionally, it is possible to determine the reference impedance values before commissioning the dispensing device and/or before a dispensing mode. Furthermore, it is possible to determine the reference impedance values at predetermined times and/or after maintenance of the dispensing device, in particular after replacement of the actuator.

In the sense of the invention, reference impedance values are understood to be impedance values that result when the actuator is in an ideal state. In the ideal state, the actuator is adjusted so that liquid samples are repeatedly dispensed with the same physical properties.

In a particular embodiment, in order to adjust the piezoelectric actuator, the data processing apparatus can check whether the determined impedance value corresponds to the reference impedance value or is in a predetermined range having the impedance value. It can be checked whether several impedance values correspond to the associated reference impedance values or are in the predetermined range. The two values are associated with each other if an impedance value associated with a frequency of the excitation signal corresponds to a reference impedance value or is in the predetermined range associated with the same frequency of the excitation signal. The tolerances of the components of the dispensing device have no negative influence on the dispensing process if the actuator is adjusted such that the determined impedance values correspond to the reference impedance values or are in the predetermined range.

The actuator can be adjusted such that the determined impedance value corresponds to the reference impedance value or is in the predetermined range having the reference impedance value. As described above, this can be done by changing the bias on the actuator. As part of a regulation process, the mechanical bias can be changed until the above adjustment condition is met. The actuator can be adjusted by the data processing apparatus.

Alternatively or additionally, a deviation between the determined impedance value and the reference impedance value can be taken into account in an excitation signal in a dispensing mode of the dispensing device. In this way, the amplitude of the excitation signal in dispensing mode can be selected so that the deviation ascertained in adjustment mode is compensated for. As a result, comparable liquid samples can also be obtained in this way in dispensing mode. The excitation signals to be applied to the actuator in dispensing mode, which depend on the deviation, can be stored in a memory.

In another embodiment, the actuator can be adjusted as follows. This method can be carried out in addition to or as an alternative to the method described above. The following examination of the reference impedance values can be carried out by the data processing apparatus.

During the adjustment mode, a reference impedance value and/or a reference frequency value for a reference impedance point can be determined. A reference impedance point is a point associated with a reference impedance value and a reference frequency value. Reference impedance values and/or reference frequency values can be determined for several reference impedance points. The reference impedance point can be a resonance point or an anti-resonance point. A resonance point has an impedance value that is a local impedance minimum, and the anti-resonance point has an impedance value that is a local impedance maximum. As a result, after examining the determined reference impedance values, all reference impedance values and/or reference frequencies of characteristic reference impedance points, such as resonance points and/or anti-resonance points, are known.

In addition, a reference frequency difference between two reference impedance points can be ascertained. In this way, at least one reference frequency range between resonance points or between anti-resonance points can be ascertained. Alternatively or additionally, a reference frequency difference between a resonance point and an anti-resonance point can be determined. In addition, a number of reference impedance points, in particular a number of resonance points and/or a number of anti-resonance points, can be ascertained in a reference frequency range.

The data processing apparatus can check as an adjustment condition whether a certain impedance point, such as a resonance point or anti-resonance point, corresponds to the reference impedance point, such as the reference resonance point or the reference anti-resonance point, or is in a predetermined range having the impedance point. In particular, it can be checked whether the impedance value of the impedance point corresponds to the reference impedance value of the reference impedance point or is in a predetermined range that has the reference impedance value and/or whether the frequency value of the impedance point corresponds to the reference frequency value of the reference impedance point or is in a predetermined range that has the reference frequency value. An impedance point is a point associated with an impedance value and a frequency value.

In addition, as an adjustment condition, it can be checked whether there is a frequency difference between two impedance points that corresponds to the reference frequency difference or is in a predetermined range that has the reference frequency difference. In addition, as an adjustment condition, it can be checked whether there are a number of impedance points in a frequency range that correspond to the number of reference impedance points in the reference frequency range. It can be checked whether the frequency range corresponds to the reference frequency range or is shifted by a predetermined range to the reference frequency range.

Compared to the previously described method, the aforementioned adjustment conditions provide the advantage that not every impedance value is used to adjust the actuator, but only certain ranges and/or impedance points. This allows the actuator to be adjusted quickly.

The data processing apparatus adjusts the actuator according to the test result. Thus, the actuator can be adjusted such that the measured impedance value of the impedance point corresponds to the reference impedance value of the reference impedance point or is in a predetermined range having the reference impedance value. Alternatively or additionally, the actuator can be adjusted such that the frequency value of the impedance point corresponds to the reference frequency value of the reference impedance point or is in a predetermined range having the reference frequency value. Furthermore, the data processing apparatus can adjust the actuator such that the frequency difference between two impedance points corresponds to the reference frequency difference or is in a predetermined range having the reference frequency difference.

In addition, the data processing apparatus can adjust the actuator such that there are a number of impedance points which correspond to the number of reference impedance points in the reference frequency range. The data processing apparatus can adjust the actuator in such a way that the frequency range is shifted such that it corresponds to the reference frequency range or the offset between the frequency range and the reference frequency range is in a predetermined range.

The frequency range can be equal to the reference frequency range. In this case, the same number of impedance points and reference impedance points are present in the same frequency range. In particular, it can be checked whether the same number of resonance points and/or anti-resonance points are present in the same frequency range. The number may be zero, such that there is no impedance point and/or reference impedance point in the frequency range.

As described above, the actuator can be adjusted by changing the mechanical bias applied to the actuator. By changing the mechanical bias, at least one impedance point or several impedance points can be caused to shift with respect to their impedance value and/or frequency value. The at least one impedance point can be shifted in such a way that at least one of the above-mentioned adjustment conditions is met.

Alternatively or additionally, the excitation signal to the actuator in dispensing mode can be changed according to the test result of the adjustment mode. By changing the excitation signal, in particular the amplitude of the excitation signal, a mechanical bias that is too high or too low can be compensated for. Thus, by using the excitation signal in dispensing mode, the actuator can be precisely adjusted.

As explained in more detail below, the actuator can be easily adjusted by checking whether one or more adjustment conditions are met. This is possible because the tolerances of the components of the dispensing devices are reflected in the impedance values and therefore a target state for the actuator can be easily adjusted by considering the impedance values. In particular, it has been found that the actuator can be easily adjusted if the ascertained impedance values are examined to determine whether a resonance and/or an anti-resonance is present in at least one predetermined frequency range and/or whether at least one impedance value is in a predetermined impedance range and/or whether a predetermined number of resonances and/or anti-resonances are present in a predetermined frequency range.

The change in bias described above can be carried out as part of a regulation process by the data processing apparatus. As part of the regulation process, the data processing apparatus can cause the transmission of one or more control signals and the associated ascertainment of impedance values to be carried out several times in succession until at least one of the above-mentioned adjustment conditions or several adjustment conditions are met.

In a particular embodiment, at least one further impedance value, in particular several further impedance values, can be determined for adjusting the piezoelectric actuator. The actuator is not biased during the determination process. Therefore, the impedance value is influenced by the actuator and not by the piston and/or dispenser and/or the biasing apparatus. The adjustment of the actuator on the basis of this method can be carried out alternatively or in addition to one of the two embodiments described above or in addition to both embodiments described above.

The data processing apparatus can ascertain at least one reference deviation of the reference impedance value from the further impedance value. In addition, a deviation between the at least one impedance value and the further impedance value can be ascertained. It is also possible that several reference deviations and several deviations are determined in an analogous manner. The actuator can be adjusted in such a way that the deviation corresponds to the reference deviation or is within a predetermined range having the reference deviation. If several deviations and several reference deviations are determined, the actuator can be adjusted such that the deviation corresponds to the associated reference deviation in each case or is in the predetermined range.

The data processing apparatus can also change the bias of the piezoelectric actuator in this method for adjusting the actuator. In this method, however, the change in bias can be carried out as part of a regulation process by the data processing apparatus. As part of the regulation process, the data processing apparatus can cause the transmission of at least one control signal and the associated ascertainment of impedance values to be carried out several times until the at least one deviation corresponds to the reference deviation or is in the predetermined range.

Alternatively or additionally, the data processing apparatus can change an amplitude of the control signal in dispensing mode. The change depends on the test result from the adjustment mode. The amount of change depends on the extent to which the deviation differs from the reference deviation.

This method takes advantage of the fact that the reference deviations of the further impedance values and the reference impedance values are constant or substantially constant, regardless of the tolerances in the dispensing device. Therefore, in the adjustment mode of the actuator, if the deviation between the ascertained impedance values for a biased actuator and the other impedance values is known, the change in the bias and/or the amplitude of the excitation signal can be easily determined. The bias must be changed in such a way that the deviation between the ascertained impedance values and the further impedance values corresponds to the reference deviation or is in the predetermined range. Alternatively or additionally, the amplitude of the excitation signal can be changed in dispensing mode so that the dispensed liquid samples are comparable.

After the piezoelectric actuator has been adjusted by changing the bias using the biasing apparatus and/or after it is known that the control signal must be changed in dispensing mode, the adjustment mode of the actuator is terminated. The dispensing device can thus be transferred to the dispensing mode in which a liquid sample is dispensed. The bias is changed to the bias ascertained during adjustment mode and/or the dispensing process(es) is/are carried out with the bias ascertained in adjustment mode and/or with the control signal.

A dispenser is understood to mean an apparatus that receives a liquid sample. In addition, the dispenser dispenses a liquid sample after actuation by the piston or actuator in dispensing mode. The liquid sample is dispensed through an outlet opening of the dispenser. The outlet opening is dimensioned in such a way that no liquid sample escapes from the dispenser due to capillary forces when the dispenser is not actuated by the piston or actuator.

The dispenser can be inserted detachably in a holder of the dispensing device. This makes it possible to exchange the dispenser, for example to avoid contamination of liquid samples. The dispenser may include the dispenser section that is actuated by the piston or actuator to dispense a liquid sample. The dispenser section may be made of a material that is different from the material of the rest of the dispenser. In particular, the dispenser section can have a mechanical membrane, which is actuated by the piston to dispense a liquid sample. The dispenser section can have the outlet opening through which the liquid sample exits the dispenser. In addition, the dispenser may have a receiving space with a receiving opening for introducing a liquid sample into the dispenser. The receiving space can be fluidically connected to the outlet opening by means of an outlet channel, the outlet channel extending at least partially in the dispenser section. The outlet channel can have a smaller flow cross-section than the receiving space.

The dispensing device can have a deflection and/or suction apparatus. The deflection apparatus serves to deflect the dispensed liquid sample, in particular the dispensed droplet. The suction apparatus is used to suction off the dispensed liquid sample. The dispensed liquid can be diverted and/or suctioned into a waste receptacle. The deflection and/or suction can take place before the liquid that is dispensed enters the receptacle, in particular the receptacle of a microtiter plate. The dispensed liquid can be deflected and/or suctioned off if the liquid does not contain any particles. Alternatively, the liquid that is dispensed can be deflected and/or suctioned off if the number of particles contained in the liquid is greater or less than a predetermined value, in particular greater than 1.

Of particular advantage is a data processing apparatus that has means by which the method according to the invention can be carried out. The data processing apparatus can have an excitation unit for outputting the excitation signal. In addition, the data processing apparatus can have a computing unit. The computing unit can be configured to determine the impedance values based on the received data and/or adjust the actuator in the manner described above.

The data processing apparatus can have a processor. In addition, the data processing apparatus can have a circuit board with electrical components, such as the processor. For example, the impedance value can be determined using the electrical components. The data processing apparatus can be designed in such a way that it adjusts the actuator. Furthermore, the data processing apparatus can be designed such that it controls and/or regulates the dispensing mode of the dispensing device. Alternatively, another data processing apparatus may be present by means of which the dispensing mode of the dispensing device is controlled or regulated.

Of particular advantage is a computer program which comprises instructions which, when the program is executed by a computer, cause the computer to carry out the method according to the invention. The computer may be the data processing apparatus mentioned above. In addition, there is a computer-readable data carrier on which the computer program is stored. It is also advantageous to have a data carrier signal that transmits the computer program.

The subject matter of the invention is shown schematically in the drawings, in which elements that are the same or have the same effect are mostly provided with the same reference signs. In the drawings:

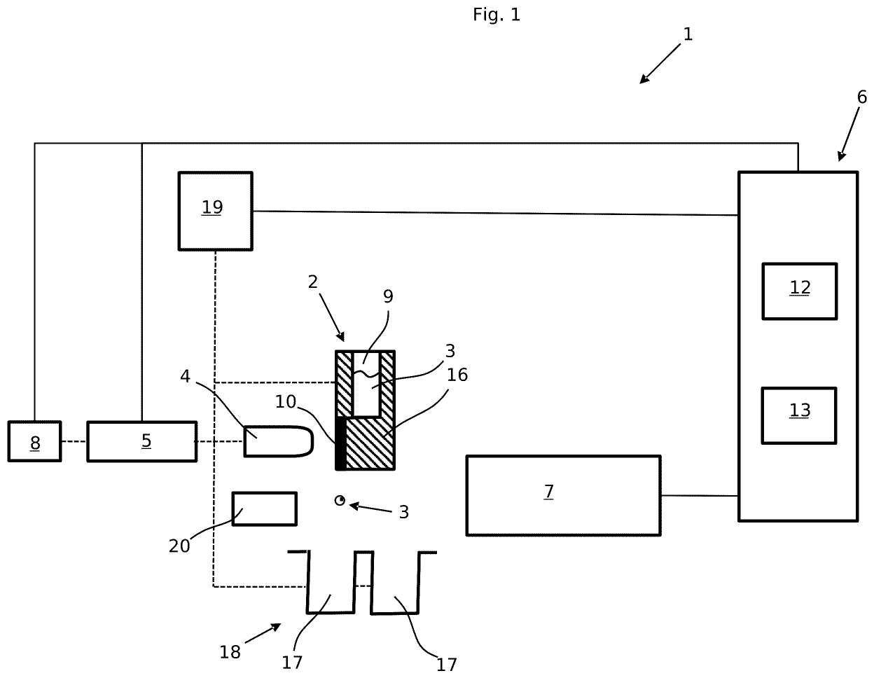

FIG. 1 shows a schematic representation of a dispensing device according to the invention;

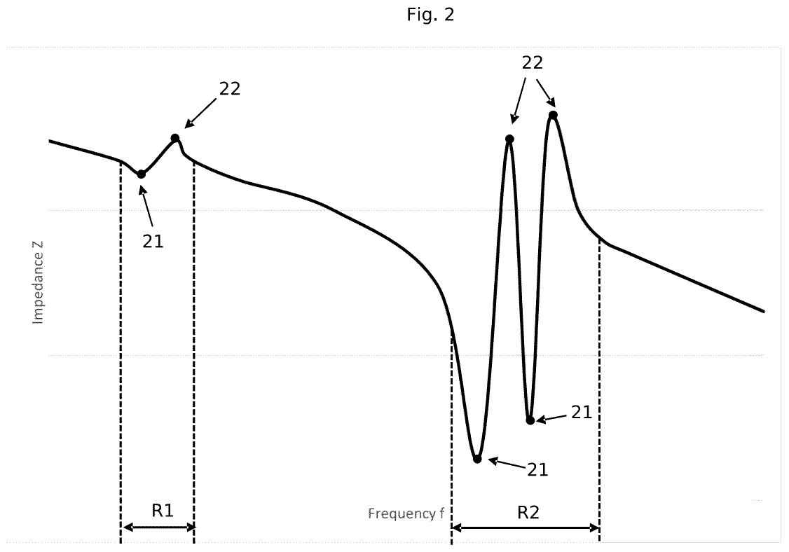

FIG. 2 shows a reference impedance curve in a state in which the piezoelectric actuator is biased with an ideal load;

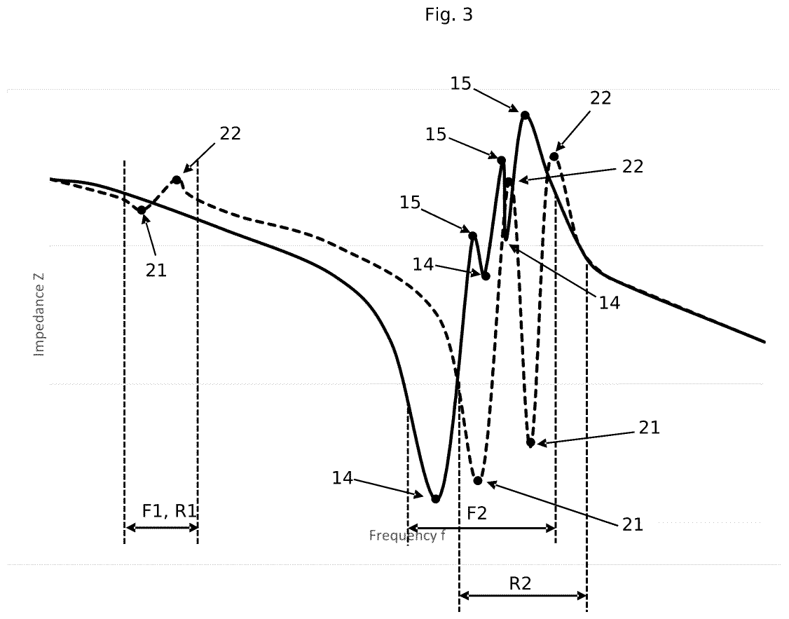

FIG. 3 shows impedance curves in a state in which the piezoelectric actuator is biased with too low a load and in a state in which the piezoelectric actuator is biased with an ideal load,

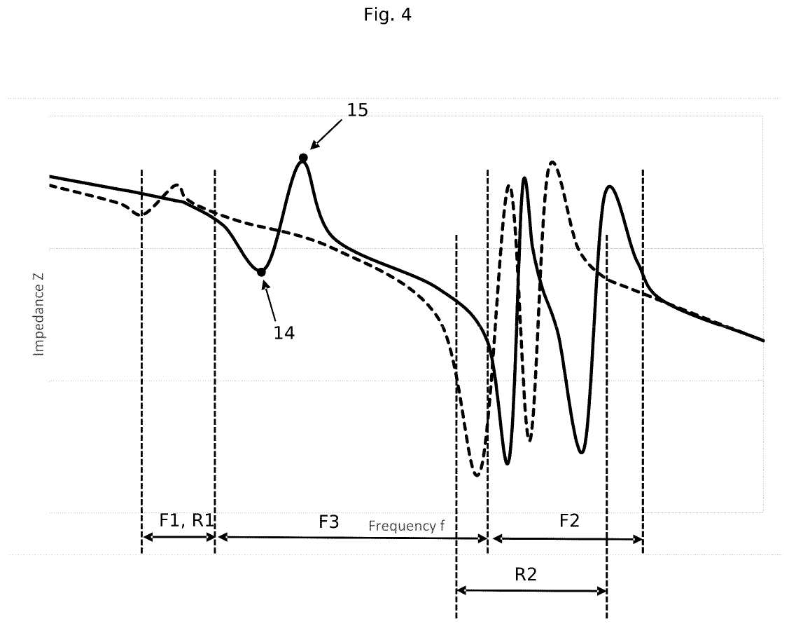

FIG. 4 shows an impedance curve in a state in which the piezoelectric actuator is biased with too high a load and in a state in which the piezoelectric actuator is biased with an ideal load;

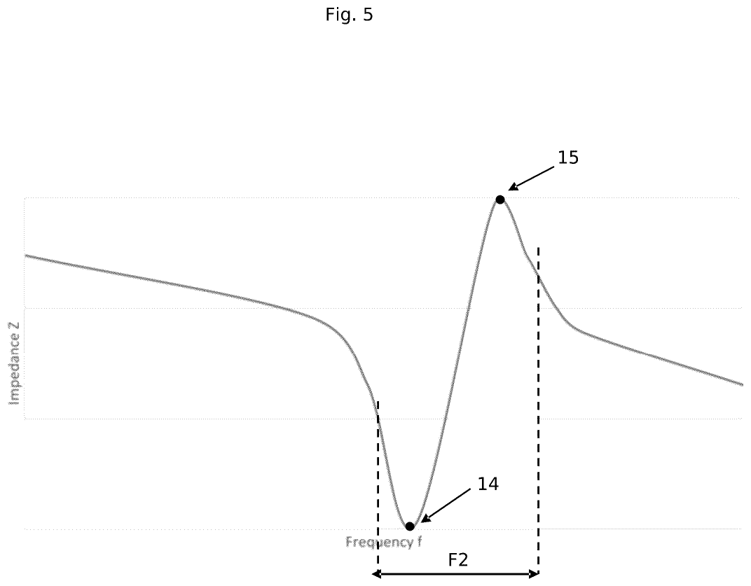

FIG. 5 shows an impedance curve for the actuation system in a state in which the piezoelectric actuator is not biased;

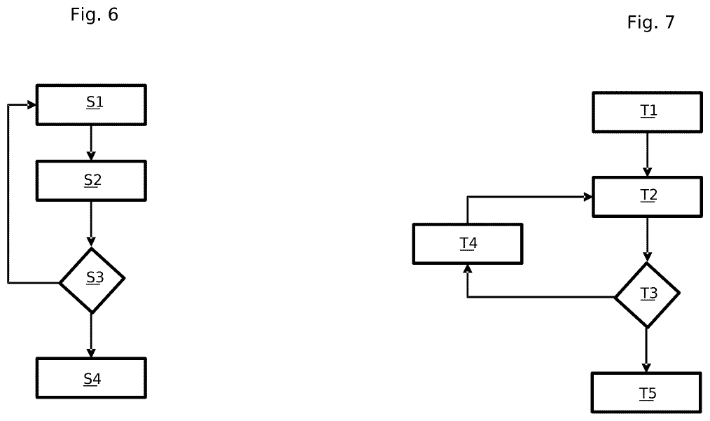

FIG. 6 shows a flow chart illustrating the ascertainment of reference impedance values;

FIG. 7 shows a flow chart illustrating a method for adjusting the piezoelectric actuator according to a first embodiment;

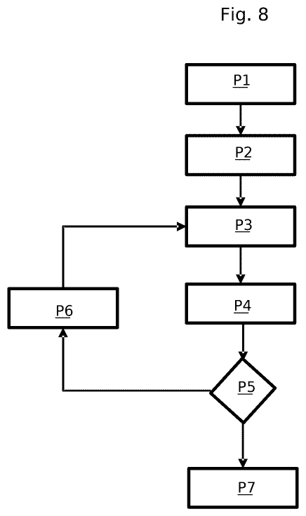

FIG. 8 shows a flow chart illustrating a method for adjusting the piezoelectric actuator according to a second embodiment;

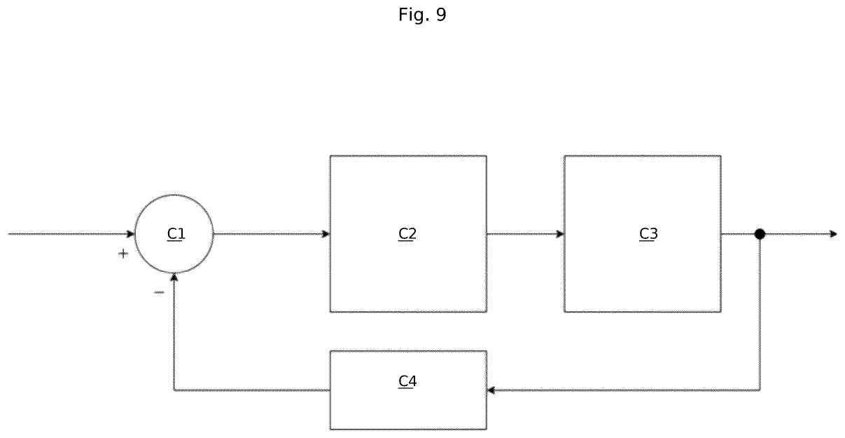

FIG. 9 shows a control diagram for adjusting the piezoelectric actuator according to a third embodiment.

A dispensing device 1 shown in FIG. 1 has a dispenser 2 for receiving a liquid sample 3. Furthermore, the dispensing device 1 has a piston 4 for actuating the dispenser 2 to dispense a liquid sample 3 from the dispenser 2. In addition, the dispensing device 1 has a piezoelectric actuator 5 for actuating the piston 4 and a data processing apparatus 6.

The data processing apparatus 6 is configured to transmit several excitation signals to the actuator 5. In a dispensing mode of the dispensing device 1, the actuator 5 actuates the piston 4 on the basis of the excitation signals, which results in the piston 4 actuating the dispenser 2 to dispense a liquid sample 3 from the dispenser 2. The data processing apparatus 6 has an excitation unit 12 for generating the excitation signals.

The dispensing device 1 also has a biasing apparatus 8, by means of which the piezoelectric actuator 5 is mechanically biased with a load. The mechanical biasing apparatus 8 is electrically connected to the data processing apparatus 6. Therefore, the data processing apparatus 6 can control the mechanical bias by transmitting control signals to, for example, a motor of the biasing apparatus 8. In an alternative embodiment not shown, the biasing apparatus 8 can be actuated manually in order to adjust the bias applied to the actuator.

The dispenser 2 can have a receiving space 9 which serves to receive the liquid sample 3. The receiving space 9 has an inlet opening through which the liquid sample 3 is fed into the receiving chamber 9. Furthermore, the dispenser 2 can have a dispenser body 16 which is transparent and designed as a solid body. The dispenser 15 can be a droplet generator which, as shown in FIG. 5, dispenses the liquid in the form of a droplet.

In addition, the dispenser 2 has a dispenser section 10 which is fluidically connected to the receiving space 9. The dispenser section 10 has an outlet opening through which liquid sample exits the dispenser 2. The outlet opening has such a geometry that the liquid sample cannot escape from the outlet opening due to capillary forces when the piston 3 does not actuate the dispenser section 10. The dispenser has an outlet channel which is fluidically connected at one end to the outlet opening and at the other end to the receiving space. The outlet channel extends partially through the dispenser section 10 and has a smaller flow cross-section than the receiving space 9. The dispenser section 10 has a flexible membrane and is made of a different material than the dispenser body 16.

The dispensed liquid sample 3 can contain only liquid. Alternatively, the dispensed liquid sample 3 may contain one or more particles. In dispensing mode, the dispensed liquid sample 3 has a predetermined number of particles and is dispensed into a receptacle 17.

The dispensing device 1 has a holding apparatus (not shown) which supports the receptacles 17. The receptacles 17 can be part of a microtiter plate 18. In addition, the dispensing device 1 has a displacement apparatus 19 by means of which the dispenser 2 and the microtiter plate 18 can be displaced relative to one another. This makes it possible to set the receptacle into which the liquid sample is dispensed. The displacement apparatus 19 is electrically connected to the data processing apparatus 6 and is controlled by the data processing apparatus 6.

The dispensing device 1 also has an optical detection apparatus 7. The optical detection apparatus 7 is configured such that it can detect the dispensed liquid sample 3. In addition, the optical detection apparatus 7 is configured to detect at least a part of the outlet channel and the outlet opening. The optical detection apparatus 7 can determine whether the dispensed liquid sample 3 has a predetermined physical property. The optical detection apparatus 7 is electrically connected to the data processing apparatus 6.

In addition, the dispensing device 1 has a suction or deflection apparatus by means of which the dispensed liquid sample 3 can be suctioned or deflected before the liquid sample enters the receptacle 17. Suction and/or deflection is usually performed in dispensing mode when the dispensed liquid sample does not contain a predetermined number of particles.

As described above, a liquid sample 3 is dispensed when the dispenser section 10 is actuated by the piston 4. For this purpose, the piston 4 is actuated by the piezoelectric actuator 5, and the piston 4 moves linearly. The piston 4 is actuated according to the excitation signal transmitted by the data processing apparatus 6 to the actuator 5.

The dispensing device 1 can be operated in an adjustment mode. In adjustment mode, the actuator 5 is adjusted such that the liquid samples 3 dispensed in a dispensing mode are comparable. This is the case, for example, if the liquid samples 3 have the same shape and/or the same volume and/or the same speed.

In adjustment mode, the data processing apparatus 6 transmits at least one excitation signal to the actuator 5 biased by means of the biasing apparatus 8. In addition, at least one impedance value of the excited actuator 5 is determined. The data processing apparatus 6 is configured to receive data. The received data may contain information about voltage and/or current. The data processing apparatus 6 can determine the at least one impedance value based on the received data. For this purpose, the data processing apparatus 6 has a computing unit 13 by means of which the at least one impedance value is determined. The data processing apparatus 6 adjusts the piezoelectric actuator 5 according to the impedances of the actuation system 11.

In an alternative dispensing device 1, not shown in the figures, the dispensing device 1 can have a measuring apparatus that determines the impedances. In this embodiment, the determined impedances are transmitted to the data processing apparatus 6.

In FIG. 1, mechanical connections between components are shown with a dashed line and electrical connections between components are shown with a solid line.

FIG. 2 shows a reference impedance curve in a state in which the piezoelectric actuator 5 is biased with an ideal load. The reference impedance curve depends on the frequency of the excitation signal transmitted to actuator 5. The reference impedance curve corresponds to the impedance curve that is present when the actuator 5 is biased, with which the dispensed liquid sample 3 has a predetermined property in the dispensing mode of the dispensing device. In this case, the liquid samples dispensed in a dispensing mode are comparable. Thus, the reference impedance curve represents the desired impedance curve, so the three methods described in more detail below are intended to ensure that the actuator 5 is adjusted such that the determined impedance curve corresponds to the reference impedance curve. The ascertaining of the reference impedance curve is described in more detail in FIG. 6.

The reference impedance curve has some characteristic reference frequency ranges and/or reference impedance points. There is a first reference frequency range R1 which has two characteristic reference impedance points. The reference impedance points are a reference resonance point 21 and a reference anti-resonance point 22.

In addition, there is a second reference frequency range R2, which has four characteristic reference impedance points. Thus, the second reference frequency range has two reference resonance points 21 and two reference anti-resonance points 22. The two reference resonance points 21 differ from each other with respect to their reference impedance value. Likewise, the two reference anti-resonance points differ from each other with respect to their reference impedance values. The first reference frequency range R1 has a lower frequency than the second reference frequency range R2.

The width of the second reference frequency range R2 corresponds to the width of the second frequency range F2 in a state in which the actuator 5 is not biased. This state is shown in FIG. 5. The second reference frequency range R2 is selected analogously to the second frequency range F2 shown in FIG. 5 such that it has a reference resonance point and a reference anti-resonance point. The reference resonance point can be the reference resonance point with the lowest impedance value.

FIG. 3 shows impedance curves in a state in which the piezoelectric actuator is biased with too low a load and in a state in which the piezoelectric actuator is biased with an ideal load. The impedance curve in the state in which the piezoelectric actuator is biased with the ideal load is shown as a dashed line. The dashed impedance curve corresponds to the reference impedance curve shown in FIG. 2. The impedance curve depends on the frequency of the excitation signal transmitted to actuator 5.

As can be seen from FIG. 3, the impedance curve and the reference impedance curve differ. Thus, the impedance curve in a first frequency range F1, which corresponds to the reference frequency range R1, has no characteristic impedance points. In particular, the impedance curve in the first frequency range F1 has no resonance point and no anti-resonance point. In other words, the number of impedance points in the first frequency range differs from the number of reference impedance points in the first reference frequency range.

The impedance curve also differs from the reference impedance curve in the second frequency range F2. Thus, the second frequency range F2 is shifted from the reference frequency range towards lower frequencies. Analogously to the second reference resonance point, the second frequency range F2 comprises the resonance point with the lowest impedance value and a predetermined range around the resonance point.

The impedance curve has six characteristic impedance points, whereas the reference impedance curve has only four characteristic impedance points. In particular, the impedance curve has three resonance points 14 and three anti-resonance points 15 and the reference impedance curve has two reference resonance points 21 and two reference anti-resonance points 22. In other words, the number of impedance points is different from the number of reference impedance points in the second frequency range.

Another difference is that the impedance values of the resonance points differ significantly from the reference impedance values of the reference resonance points. The same applies to the impedance values of the anti-resonance points.

In addition, there is a difference in that a frequency difference between two impedance points is significantly different from a reference frequency difference between two reference impedance points. The frequency difference can be determined between frequency values associated with the resonance points or between a frequency value associated with a resonance point and a frequency value associated with an anti-resonance point.

FIG. 4 shows an impedance curve in a state in which the piezoelectric actuator is biased with too high a load and in a state in which the piezoelectric actuator is biased with an ideal load. The impedance curve in the state in which the piezoelectric actuator is biased with the ideal load is shown as a dashed line. The dashed reference impedance curve corresponds to the reference impedance curve shown in FIG. 2. The impedance curve depends on the frequency of the excitation signal transmitted to actuator 5.

The impedance curve differs from the reference impedance curve. Thus, analogously to the impedance curve shown in FIG. 3, the impedance curve in the first frequency range F1 has no characteristic impedance points, i.e., no resonance point and no anti-resonance point.

In a third frequency range F3 of the impedance curve, which is between the first and second frequency ranges, there are two characteristic impedance points, namely a resonance point 14 and an anti-resonance point 15. This is not the case with the reference impedance curve. In addition, the impedance values of the impedance points occurring in the third frequency range F3 differ from the reference impedance values of the reference impedance points present in the second reference frequency range R2.

A further difference is that the second frequency range F2 is shifted towards higher frequencies starting from the second reference frequency range R2.

FIG. 5 shows an impedance curve in a state in which the piezoelectric actuator 5 is not biased. In the state shown in FIG. 5, no load is exerted on the actuator 5 by the biasing apparatus 8. The impedance curve has two impedance points in the second frequency range F2, namely a resonance point 14 and an anti-resonance point 15. The second frequency range F2 is selected such that it contains the two impedance points 14, 15. In other words, after determining the impedance curve in the state in which the actuator 5 is not biased, the width of the second frequency range F2 is known. This width is used to define the second reference frequency range R2 and for the impedance curves shown in FIGS. 3 and 4. This makes it possible to determine whether the second frequency range is shifted compared to the second reference frequency range R2 or not.

FIG. 6 shows a flow chart for determining reference impedance values. In a first step S1, a dispensing process is carried out which has one or more dispensing steps. One liquid sample is dispensed per dispensing step. For this purpose, the piston 4 is actuated by the actuator 5, and the actuator 5 receives at least one excitation signal, in particular a voltage signal, from the data processing apparatus 6. During the dispensing processes, the mechanical bias of the actuator 5 is not changed.

In a second step S2, the optical detection apparatus 7 detects the dispensed liquid sample. The optical detection apparatus ascertains a physical property of the dispensed liquid sample 3. The physical property may be the volume of the liquid sample and/or the shape of the dispensed liquid and/or the speed of the liquid sample and/or other properties. In a third step S3, it is checked for each dispensed liquid sample 3 whether the ascertained physical property corresponds to a predetermined property. The test can be carried out in the optical detection apparatus 7 or in the data processing apparatus 6. Alternatively, the check can be done manually.

If the condition is not met, the bias of the actuator 5 is changed by the biasing apparatus 8 and steps S1 to S3 are carried out again. This means that another dispensing process is performed with one or more dispensing steps.

If the condition is met, a reference impedance measurement is carried out in the fourth step S4. The actuator 5 is biased with the bias that corresponds to the bias of the actuator 5 at which the liquid samples 3 were dispensed that have the predetermined property. For this purpose, at least one excitation signal is transmitted to the actuator 5 and at least one reference impedance value, in particular several reference impedance values, are ascertained. The excitation signal can be varied in frequency. Alternatively, several excitation signals that differ from each other in terms of frequency can be transmitted to the actuator 5, thus determining several reference impedance values.

FIG. 7 shows a flow chart illustrating a method for adjusting the piezoelectric actuator 5 according to a first embodiment. In a first method step T1, a dispenser 2 is inserted into a holder of the dispensing device 1.

In a second step T2, the data processing apparatus 6 goes into an adjustment mode in which at least one excitation signal is transmitted to the piezoelectric actuator 5, the frequency of which excitation signal varies over time. Alternatively, the actuator 5 can be supplied with excitation signals that differ from each other in terms of their frequency. The mechanical bias is not changed during the transmission of the at least one excitation signal and/or during the determination of the impedance values. The data processing apparatus 6 determines at least one impedance value for each excitation signal. Thus, after passing through a predetermined frequency range, there are several impedance values.

In a third step T3, it is checked on the basis of the ascertained impedance values whether the actuator 5 is correctly adjusted. A correctly adjusted actuator 5 ensures that the dispensed liquid sample 3 has the desired physical property in the dispensing mode of the dispensing device 1. The test takes advantage of the fact that the reference impedance curve (see FIG. 2) is known. In particular, after an examination of the reference impedance curve, the reference frequency range R1, R2 and/or reference impedance points 21, 22 are known and can be used to assess whether the actuator 5 is correctly adjusted.

This is possible because it is known from the reference impedance curve in which reference frequency sections R1, R2 resonances and/or anti-resonances are present and in what number. In addition, the impedance values of, for example, resonances and/or anti-resonances in the reference frequency sections R1, R2 are known from the reference impedance curve and are used to draw a conclusion as to whether the actuator 5 is correctly adjusted.

For this purpose, in the third step T3 it can be checked whether one or more of the following adjustment conditions are met or not. In this way, it can be checked whether a resonance and an anti-resonance are present in a first frequency range F1 of the impedance curve. In addition, it can be checked whether the second frequency range F2 corresponds to the second reference frequency range or is offset from it. Depending on whether the offset is directed towards smaller or larger frequencies, it can be determined whether the bias applied to the actuator is too low or too high.

In addition, it can be checked whether the number of impedance points present in the second frequency range, namely resonance points and/or anti-resonance points, corresponds to the number of reference impedance points. Alternatively or additionally, it can be checked whether the impedance values of the impedance points in the second frequency section differ significantly from the impedance values of the impedance points in the second reference frequency section.

In addition, it is possible to check whether a frequency difference between two impedance points corresponds to a reference frequency difference or is in a predetermined range. In addition, the third frequency range F3 can be checked to see whether it contains a resonance point and an anti-resonance point.

The data processing apparatus 6 carries out the above-mentioned tests and determines, based on the test result or results, whether the actuator 5 is correctly adjusted. The actuator 5 is correctly adjusted if the test or tests show that the impedance values meet the conditions described in FIG. 2.

If one or more adjustment conditions are not met, the data processing apparatus can determine whether the bias is too high or too low based on the test result or test results. Then, in a fourth step S4, the actuator 5 is adjusted. In particular, the bias of the actuator 5 can be changed by the biasing apparatus 8. Subsequently, the second and third steps T2, T3 are repeated with the changed bias. This process continues until it is determined in the third step T3 that at least one or more adjustment conditions are met.

If the adjustment conditions are met, the data processing apparatus determines that the actuator 5 is correctly adjusted. Therefore, in the fifth step T5, the adjustment mode is terminated and the dispensing mode of the dispensing device 1 is started. In dispensing mode, the actuator 5 is biased with the bias ascertained in adjustment mode.

FIG. 8 shows a flow chart illustrating a method for adjusting the piezoelectric actuator 5 according to a second embodiment. The first step P1 corresponds to step T1 in FIG. 7, so reference is made to the above explanations.

In a second step P2, analogously to the second step T2, the actuator 5 is supplied with at least one excitation signal which has a frequency that varies over time. Alternatively, several excitation signals that differ from one another in terms of their frequency can be supplied to the actuator. In contrast to the second step T2 in FIG. 2, however, the actuator 5 is not biased. This means that the data processing apparatus 6 ascertains further impedance values which have the curve shown in FIG. 5.

In a third step P3, an impedance measurement is carried out again. For this purpose, at least one excitation signal is supplied to the actuator 5, the frequency of which varies over time. Alternatively, several excitation signals that differ from one another in terms of their frequency can be supplied to the actuator. In contrast to the second step P2, however, the actuator 5 is mechanically biased by the biasing apparatus 8. The impedance values are determined analogously to the second step P2. Assuming that the actuator 5 is not correctly adjusted, impedance values are obtained which have the curve shown in FIG. 3 or FIG. 4 or a similar curve.

In a fourth step P4, at least one deviation between the impedance values ascertained in the third step P3 and the impedance values ascertained in the second step P2 is ascertained. In a fifth step P5, it is determined whether the at least one deviation corresponds to a reference deviation. The reference deviation corresponds to a deviation between the further impedance values, which were ascertained in a non-biased state of the actuator and are shown as the curve in FIG. 5, and reference impedance values, which were ascertained analogously to the method described in FIG. 6 and are shown in FIG. 2.

The data processing apparatus 6 checks whether the at least one deviation corresponds to the reference deviation or is in a predetermined range containing the reference deviation. If this is not the case, the actuator 5 is adjusted in a sixth step P6. The adjustment is carried out analogously to the fourth step from FIG. 7 by changing the mechanical bias applied to the actuator 5. Subsequently, steps P3 and P4 are repeated until the adjustment condition in the fourth step P4 is met.

If the check in the fifth step P5 shows that the adjustment condition is met, the data processing apparatus ends the adjustment mode in the seventh step P7 and switches to the dispensing mode. In dispensing mode, actuator 5 is biased with the bias ascertained in adjustment mode.

FIG. 9 shows a control diagram for adjusting the piezoelectric actuator 5 according to a third embodiment. The third embodiment differs from the two embodiments, for which the sequences are shown in FIG. 7 and FIG. 8, in that for each impedance value it is checked whether it corresponds to a reference impedance value or is in a predetermined range that contains the reference impedance value. This is explained in more detail below. In contrast, the impedance measurement is carried out analogously to the two methods by transmitting at least one excitation signal, in particular several excitation signals, to the actuator 5. In this regard, reference is made to the above explanations.

The regulation steps mentioned below can be carried out in the data processing apparatus 6. In a first regulation step C1, for an impedance value, in particular each impedance value, a deviation from a reference impedance value associated with the impedance value is determined. The impedance value and the reference impedance value are associated with each other via the frequency value of the excitation signal. Both values have the same frequency value.

In a second regulation step C2, it is checked whether the deviation is within a predetermined range. According to the test result, it is determined in a third regulation step C3 whether actuator 5 is correctly adjusted or needs to be adjusted. If the actuator 5 needs to be adjusted, a manipulated variable for the biasing apparatus 8 is output in the third regulation step C3, whereupon the biasing of the actuator 5 is changed.

The impedance measurement is carried out again in a fourth regulation step C4, but the bias of the actuator 5 has been changed on the basis of the manipulated variable. The regulation steps C1 to C3 are repeated until the deviation between the at least one impedance value and the reference impedance value is within the predetermined range. In this case, the third regulation step C3 determines that the adjustment mode has ended.

### LIST OF REFERENCE SIGNS

1 Dispensing device
2 Dispenser
3 Liquid sample
4 Piston
5 Piezoelectric actuator
6 Data processing apparatus
7 Optical detection apparatus
8 Preloading apparatus
9 Receiving space
10 Dispenser section
12 Excitation unit
13 Computing unit
14 Resonance
15 Anti-resonance
16 Dispenser body
17 Receptacle
18 Microtiter plate
19 Displacement apparatus
20 Suction/deflection apparatus
21 Reference resonance point
22 Reference anti-resonance point
C1-C4 Steps when carrying out the method according to the third embodiment
F1 First frequency range
F2 Second frequency range
F3 Third frequency range
P1-P7 Steps when executing the method according to the second embodiment
R1 First reference frequency range
R2 Second reference frequency range
S1-S3 Steps for determining the reference impedance curve
T1-T5 Steps when executing the method according to the first embodiment

1.-30. (canceled)

31. A method for adjusting a piezoelectric actuator of a dispensing device, the method comprising:
transmitting at least one excitation signal to the actuator; and
determining at least one impedance value of the excited actuator;
wherein the piezoelectric actuator is adjusted according to the determined at least one impedance value, and wherein to adjust the actuator, a bias applied to the actuator is changed.

32. The method according to claim 31, wherein:
a. the excitation signal is a voltage signal; and/or
b. the excitation signal is within a frequency range; and/or
c. the excitation signal varies over time.

33. The method according to claim 31, wherein several excitation signals are transmitted, wherein:
a. the excitation signals differ from one another in terms of frequency; and/or
b. the excitation signals are within a predetermined frequency range.

34. The method according to claim 31, wherein determining the impedance value comprises receiving data, the data representing at least one impedance value of the excited actuator or the data used to determine at least one impedance value of the actuator.

35. The method according claim 31, wherein:
a. the impedance value is determined when the actuator is biased; and/or
b. the actuator is biased during the determination process.

36. The method according to claim 31, wherein:
a. the impedance value is determined in an adjustment mode of the dispensing device; and/or
b. an adjustment mode of the dispensing device is carried out before a dispensing mode of the dispensing device; and/or
c. an adjustment mode of the dispensing device is carried out after exchanging a dispenser of the dispensing device and/or after removing the actuator and/or after a predetermined number of dispensing steps.

37. The method according to claim 31, wherein at least one reference impedance value is determined.

38. The method according to claim 37, wherein multiple dispensing processes are carried out to determine the reference impedance values, wherein the dispensing processes differ from one another in terms of the bias applied to the actuator.

39. The method according to claim 38, wherein a physical property of a liquid sample dispensed in the dispensing process and/or of the dispensing device is determined and wherein it is checked whether the physical property meets a predetermined condition.

40. The method according to claim 39, wherein at least one reference impedance value is determined, wherein the actuator is biased with a load of the dispensing process in which the physical property meets the predetermined condition.

41. The method according to claim 31, wherein:
a. it is checked whether at least one adjustment condition is met and the actuator is adjusted according to a result of the check; and/or
b. for adjusting the piezoelectric actuator it is checked whether at least one adjustment condition is met, the adjustment condition depending on at least one reference impedance value and/or on the at least one impedance value.

42. The method according to claim 31, wherein:
to adjust the actuator, an excitation signal is ascertained which is to be applied to the actuator.

43. The method according to claim 31, wherein it is checked whether the determined impedance value corresponds to a reference impedance value or is in a predetermined range which has the reference impedance value.

44. The method according to claim 43, wherein:
a. the actuator is adjusted such that the determined impedance value corresponds to the reference impedance value or is in a predetermined range having the reference impedance value; and/or
b. a deviation between the determined impedance value and the reference impedance value is taken into account in an excitation signal in a dispensing mode of the dispensing device.

45. The method according to claim 31, wherein:
a. a reference impedance value and/or reference frequency value is ascertained for at least one reference impedance point; and/or
b. a reference frequency difference is ascertained between two reference impedance points; and/or
c. a number of reference impedance points are ascertained in a reference frequency range.

46. The method according to claim 45, wherein it is checked whether:
a. an impedance point corresponds to the reference impedance point or is in a predetermined range having the reference impedance point; and/or whether
b. there is a frequency difference between two impedance points which corresponds to the reference frequency difference or is within a predetermined range having the reference frequency difference; and/or whether
c. there are a number of impedance points in a frequency range that corresponds to the number of reference impedance points in the reference frequency range.

47. The method according to claim 31, wherein for adjusting the piezoelectric actuator at least one further impedance value is determined, wherein the actuator is not biased during the determination process.

48. The method according to claim 47, wherein a deviation between the at least one impedance value and the further impedance value is ascertained.

49. The method according to claim 31, wherein the adjusted piezoelectric actuator is used for dispensing a liquid sample in a dispensing mode of a dispensing device.

50. A non-transitory computer-readable medium comprising instructions which, when executed by a computer, cause the computer to carry out the method according to claim 31.
